(19) United States
(12) Patent Application Publication
(10) Pub. No.: US 2005/0094786 A1
(43) Pub. Date: May 5, 2005

(54) Programmable timer for electrical or electronic apparatus

(76) Inventor: Cristian A. Ossa, Edison, NJ (US)

Correspondence Address: BLANK ROME LLP, 600 NEW HAMPSHIRE AVENUE, N.W., WASHINGTON, DC, 20037, US

(21) Appl. No.: 10/698,515

(22) Filed: Nov. 3, 2003

(51) Int. Cl. H04M 15/00

(52) U.S. Cl. 379/111

(57) ABSTRACT

A programmable timer for timing the usage of electrical or electronic apparatus comprises a count up counter and a count down counter which count during the on condition of the electrical or electronic apparatus and a switch for selecting the counter output to be displayed on an LED or LCD display. A current/power sensor detects the on condition of the electrical or electronic apparatus and transmits a signal to the counters to count. A keypad is used to preset a time into the count down counter and a reset control resets the timer display to zero. When the switch is set to the count down mode, the display shows the time remaining from the preset time and when the time reaches zero, power to the electrical or electronic apparatus is interrupted. The timer has a locking cover that prevents unauthorized access to the timer controls and unauthorized removal of the electrical or electronic apparatus from the timer. A programmable microprocessor is provided for performing cost calculations based on usage of the electrical or electronic apparatus.

### BACKGROUND OF THE INVENTION

1. Field of the Invention

The present invention relates to timer controls, and more particularly to a programmable timer for controlling or monitoring the usage of hard-wired electrical or electronic apparatus, such as a television set, a telephone or an Internet connection.

2. Description of the Prior Art

Timer controls and locking devices for electrical apparatus and appliances, such as a television set, are well known in the art. Several of such devices are disclosed in U.S. Pat. No. 4,246,495 to Pressman; U.S. Pat. No. 4,482,789 to McVey; U.S. Pat. No. 4,484,220 to Beetner; U.S. Pat. No. 4,588,901 to Maclay et al. and U.S. Pat. No. 5,125,492 to Treleaven et al., the disclosures of which are incorporated herein by reference. The timing devices of Beetner, Maclay et al. and Treleaven et al. include a connector housing for the electrical components of the timer which is removably connectable by a power plug to a conventional power outlet or receptacle. The connector housing includes a lockable enclosure for a power receptacle to which the power plug of the television set is electrically connected and locked so that a user may not plug the television set directly into a power receptacle and thereby bypass the timing device. A number of other types of timing devices, including programmable devices controlled by microprocessors have been heretofore proposed, as exemplified by the timing devices disclosed in U.S. Pat. No. 4,145,617 to Lee et al.; U.S. Pat. No. 4,570,216 to Chan; U.S. Pat. No. 4,712,019 to Nilssen; U.S. Pat. No. 4,775,801 to Baum; and U.S. Pat. No. 4,853,558 to Skarivoda, the disclosures of which are also incorporated herein by reference.

In most cases, the prior art timing devices are designed for a specific task, e.g., interrupting power to a television set when a predetermined time of operation has elapsed, turning household appliances, lighting, etc. on and off at certain programmable time intervals and the like. Typically, the prior art timing devices are used to control electrical appliances and circuits that operate with ordinary household 110-120 volt alternating current.

None of the aforementioned prior art proposals provides a versatile timing device that can be used for electrical apparatus utilizing ordinary household electrical power, for telephones utilizing telephone wiring in a building and for computers utilizing Internet connections other than telephone modems. Nor do those prior art proposals provide a timing device that can be used to interrupt power to an electrical appliance after a preset time period of usage, as well as to measure and display the total usage time of an electrical appliance or the cost of such usage.

Accordingly, it would be desirable to provide a versatile timing device that can be utilized to time the usage of electrical appliances, telephones, and Internet connections and which is adapted for use in a variety of applications, including limiting the amount of usage of electrical appliances, telephones, and Internet connections, determining the cost of usage of electrical appliances and the like.

### SUMMARY OF THE INVENTION

The present invention overcomes the drawbacks of the prior art timing devices by providing a compact timer adapted to be programmed by a person with authorization to access the timer controls, hereinafter the “timer operator” or “operator.” The timer is locked by the operator to the power plug of an electrical or electronic appliance, the RJ-11 connector of a telephone, the RJ-45 (or other type) connector of an Internet connection. The components of the programmable timer are enclosed in a sealed housing with a hinged locking cover. The housing has an electrical male plug extending from one side thereof that is adapted to be plugged into a conventional 110-120 volt receptacle, such as a common wall outlet in a home. A corresponding electrical female receptacle for receiving the power plug of an electrical appliance is mounted to the opposite side of the housing in a position to be enclosed by the hinged locking cover. A slot is formed in the hinged locking cover through which the power cord of the plugged-in electrical appliance passes. The slot is sized so that the power plug of the appliance cannot be removed from the housing when the cover is hinged to its closed position and locked. That structure prevents a user from disconnecting the electrical appliance from the timer and plugging it directly into an electrical outlet, thereby thwarting the purposes of the timer, as described in more detail hereinafter.

Instead of, or in addition to, configuring the programmable timer with a 110-120 volt power plug and receptacle, male and female telephone connectors, such as RJ-11 type connectors, or other male and female connectors, such as RJ-45 type connectors, may be mounted to the timer housing depending on a particular application. For all embodiments, the power receptacle or female connector is enclosed by the hinged lockable cover with an appropriately sized slot for receiving the cable or cord connected to the male plug of the appliance, telephone or other device for which usage is to be timed.

In a preferred embodiment, the timer is configured for two timing modes, both of which output a time count to an LED or LCD numerical display mounted on the timer housing for viewing by the user. In the first timing mode, the operator enters a desired usage time into the timer via a numerical punch pad or keypad as viewed on the LED/LCD display and during usage of the appliance (power on), a first counter counts down to zero and interrupts power to the appliance when the count reaches zero. In the second timing mode, the timer is initially set to zero time by the operator as viewed on the LED/LCD display and a second counter counts up during usage of the appliance (power on). The operator also selects the timing mode by means of a switch, sets the first timing mode usage time by means of the numerical keypad and resets the count of the second counter by a reset-to-zero control. The mode switch, keypad and reset control are enclosed within the locking cover to prevent access to those timing controls by the user or anyone other than the operator.

Also enclosed within the locking cover and thus accessible only to the operator is a stop count control connected to the first counter that interrupts the count down in the first timing mode. The stop count control may be used for an appliance (e.g., television set, telephone, Internet connection, etc.) when it is desired to use the appliance without counting the usage time. For example, if the timer is used to limit television viewing of a child, the child's parents may allow 10 hours of television viewing per week, but the parents may wish to view a program without using any of the child's allotted viewing time.

In both the first and second timing modes, when the appliance is not using power, i.e., is not turned on, the count or timing (“count up” or “count down”) is stopped and does not start or resume until the appliance is turned on and commences using power. It will be understood that for those applications of the invention that involve timing the usage of other devices, telephones, for example, counting (timing) commences when an electrical signal characteristic of usage of the telephone is sensed by a sensor and stops in the absence of such a signal.

A programmable microprocessor connected in the timer circuit controls some of the functions of the timer and the LED/LCD display. The microprocessor is programmed with the power usage specifications of commonly available appliances and electricity cost information from the local power company (dollars/kilowatt-hour). Using a function control key connected to the microprocessor, the input to the LED/LCD display may be changed by the user or operator to display the cost in dollars of the power used in either the first or second timing modes by a given appliance connected to the timer. The function key may also be used to switch the LED/LCD display in the first timing mode from the time remaining to the time counted or used.

The components of the programmable timer are ordinarily powered during use by a DC voltage obtained from an AC/DC converter in the timer circuit connected to the 110-120 volt alternating current source from the power receptacle into which the timer is plugged. When the timer is unplugged, or when there is insufficient power available from the source, a DC battery is also connected to the timer circuit.

The present invention is useful in a number of applications some, but not all, of which are described herein. Those skilled in the art will appreciate the various possible applications of the programmable timer of the invention. In a preferred application, the programmable timer of the invention is used to limit the total time an electrical apparatus can be used. Thus, the timer can be used to limit the number of hours of television viewing, video game usage, telephone usage and Internet usage. It may also be used to limit the numbers of hours rental electrical equipment can be used or, in the second timing mode, provide a basis for making a usage charge based on actual hours used for rented or leased electrical equipment. It can be used to determine waste and cost of business and industrial electrical equipment and to manage resources, such as electrical energy.

The invention has several objects, some of which are as follows:

(1) provide a simple, compact design of a versatile programmable timer;

(2) provide a programmable timer capable of use in a variety of applications, including “counting up” and “counting down” applications;

(3) provide a programmable timer capable of timing the usage of various types of electrical equipment, including television sets, telephones and the like;

(4) provide a programmable timer that can be used to determine the “cost of operation” of electrically powered machines and appliances; and

(5) provide a programmable timer that is convenient and easy to operate.

With these and other objects, advantages and features of the invention that may become hereinafter apparent, the nature of the invention may be more clearly understood by reference to the following detailed description of the invention, the appended claims and to the several attached drawings.

### BRIEF DESCRIPTION OF THE DRAWINGS

FIG. 1 is a perspective front view of a preferred embodiment of the programmable timer of the invention shown with a closed and locked cover;

FIG. 2 is a perspective front view of a preferred embodiment of the programmable timer of the invention shown with the cover in the unlocked and open position;

FIG. 3 is a perspective rear view of the programmable timer of the invention showing the various connections for the timer;

FIG. 4 is a schematic block diagram showing the components and connections of the programmable timer of the invention.

### DETAILED DESCRIPTION OF THE INVENTION

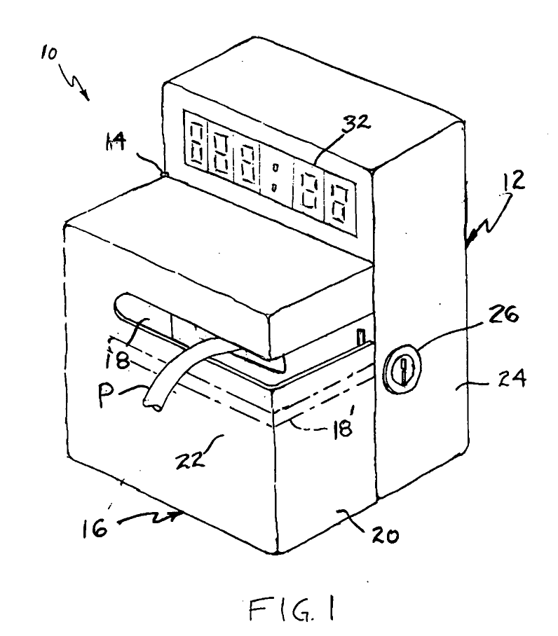

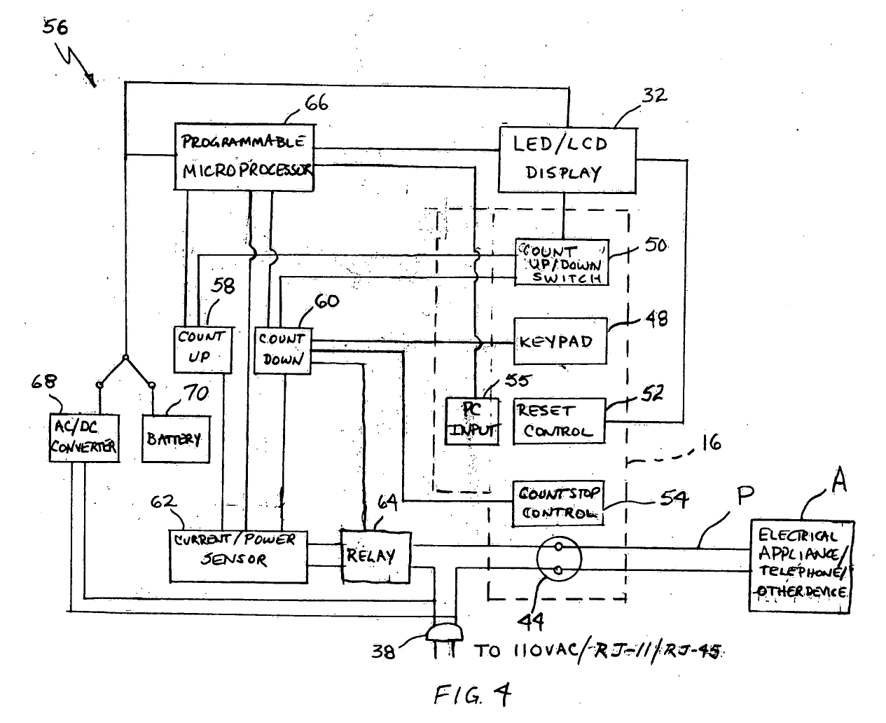

Referring now to the perspective views of FIGS. 1-3, there is shown a preferred embodiment of the programmable timer of the invention that is designated generally with reference numeral 10. Timer 10 is enclosed within a compact, sealed housing 12 in the form of a tamperproof, parallelepiped box preferably made of a metal or plastic material. The housing 12 encloses the programmable timer components, including the microprocessor, counters and timer control circuits as described in more detail hereinafter in connection with FIG. 4.

Hinged to one longitudinal edge of the housing 12 by means of a tamperproof hinge 14 is a five-sided cover 16 having a horizontal slot 18 extending through one lateral side 20 and a portion of the front side or face 22 of the cover 16. The width of slot 18 is sized large enough for the power cord P of an electrical apparatus or appliance, such as a television set, to pass through, but small enough to preclude the power plug (not shown) from passing through the slot 18. For other apparatus, such as a telephone, a second slot 18′ (shown in phantom lines only in FIG. 1) having a different width may be provided to pass the connecting cord of the other apparatus, but preclude the connector, such as an RJ-11 connector, from passing through the slot 18′. It will be understood that additional slots may be provided in the cover depending on the connecting cord diameter and connector configuration for a particular timer application.

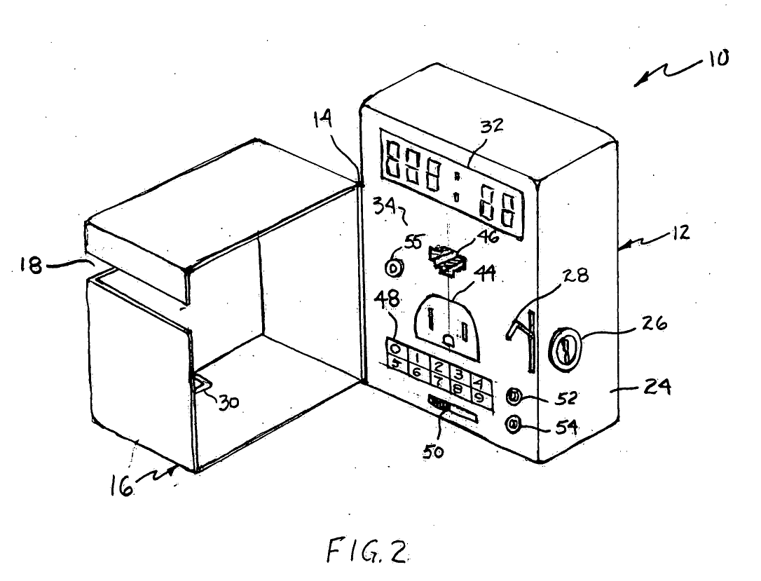

The housing 12 is provided on one lateral side 24 with a keyed locking mechanism 26 for locking the cover in the closed position shown in FIG. 1. The locking mechanism 26 shown in FIGS. 1-3 comprises a pivotable pawl 28 (FIG. 2) that is engaged with a staple 30 (FIG. 2) on the cover 16 when the cover is closed and the locking mechanism is locked as shown in FIG. 1 and is disengaged from the staple when the locking mechanism is unlocked, thereby permitting the cover to be hinged to its open position as shown in FIG. 2. Other suitable locking mechanisms may be used without departing from the scope of the invention.

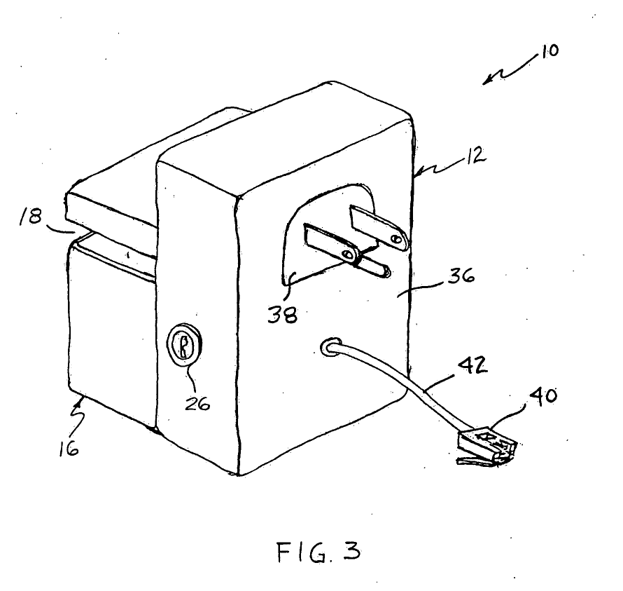

An LED or LCD display 32 is mounted to the front side 34 of the housing 12 so as to be visible to a user or operator when the cover 16 is closed and locked. The display 32 is configured for displaying time in hours and minutes and cost in dollars and cents in a well-known manner. Referring to FIG. 3, the back or rear side 36 of the housing 12 is provided with a male, three-prong power plug 38 mounted substantially flush with the surface of rear side 36 and a male RJ-11 telephone connector 40 attached to a short length of telephone wire 42. Thus, the timer 10 of this embodiment may be used for timing usage of either an electrical apparatus or appliance that uses 110-120 VAC or a telephone or other electronic device that uses an RJ-11 connector using circuitry appropriate for each application. It is also within the scope of the present invention to provide a timer 10 that has only one connector, e.g., either the power plug 38 or the RJ-11 connector 40, and the timing circuits associated with that particular connector and application.

Now referring to FIG. 2, the remaining components on the front side 34 of the housing 12 will be described. Female receptacles 44 and 46 are provided on the front side 34 in a position to be covered and inaccessible when the cover 16 is in the closed and locked position shown in FIG. 1. Receptacle 44 is configured to receive a conventional three-prong male power plug of an electrical apparatus or appliance and receptacle 46 is configured as a conventional RJ-11 female telephone jack. Each receptacle is adapted to receive its respective connector with its associated connecting cable or cord passing through the slot 18 or 18′ as the case may be.

As shown in FIG. 1, also mounted to the front side 34 of the housing 12 in positions to be enclosed and inaccessible when the cover 16 is closed and locked are timer controls comprising a numerical punch pad or keypad 48, a two position, count up/down switch 50, a reset control button 52, a count stop control button 54 and a PC input 55, the connections and functions of which are described with reference to FIG. 4.

FIG. 4 illustrates in a block diagram schematic how the timing circuit 56 of the timer 10 are connected and function with the timing of usage an electrical appliance A, it being understood that the connection and function of the timer when used with a telephone or other device is substantially the same. Timing circuit 56 includes two counters, count up counter 58 and count down counter 60, the outputs of which are selectively connected to the LED/LCD display 32 via the count up/down switch 50. Counters 58, 60 are energized to count by a current/power sensor 62 that emits an electrical output signal only when appliance A is turned on and drawing power. When the appliance A is turned off there is no output from the current/power sensor 62 and the counters 58, 60 stop counting. The current/power sensor 62 preferably has a sensing threshold that permits the turned-off appliance A to draw a small current without transmitting an output to the counters 58, 60. Such sensing threshold is useful when appliance A has an internal clock or other component that draws a small current when the appliance is connected to a power source.

The operation of the count down timing mode is as follows. With the switch 50 in the count down position, keypad 48 is connected to count down counter 60 and is used by the operator when the cover 16 is open to manually key a time into the counter 60 that is simultaneously displayed on LED/LCD display 32. After the desired time in hours and minutes is input into the counter 60 by the operator using keypad 48 and display 32, the electrical appliance A is connected by its power cord P to the receptacle 44 on the front side of the timer housing 12 and cover 16 is closed and locked with locking mechanism 26. The timer is now ready for operation. Assume the timer 10 is then plugged into a household 110-120 VAC receptacle by means of male plug 38. When the appliance A is turned on and commences using electrical power, current/power sensor 62 senses this on condition and generates an output signal to counter 60 (and counter 58) to start counting. Because the switch 50 is in the count down position, the display 32 displays the count down of the time entered into counter 60. When the time entered into the counter 60 counts to zero, counter 60 signals a relay 64 or other component to open the power circuit from power plug 38 and interrupt power to the appliance A. Because the power plug of the appliance A is locked inside the cover 16 of the timer, it cannot be removed from the timer and plugged directly into a 110-120 VAC receptacle. Nor can the switch 50, keypad 48, reset control 52, count stop control 54 or PC input 55 be accessed by anyone other than the operator.

For the count down timing mode, a count stop control button 54 is also provided that permits only the operator to stop the count down of counter 60 when the appliance A is turned on. The stop count control is useful when it is desired by the operator to interrupt the count down without resetting the count down time. For example, in a television application in which a child is subject to a television viewing time limitation, the stop count control may be activated for persons, such as parents or siblings, who are not subject to the viewing time limitation. When it is desired to reactivate the usage timing, the stop count control button 54 is again pressed to permit counter 60 to resume counting and the cover 16 is closed and locked.

The count up timing operation of the timer is much simpler than count down timing. For count up timing, the switch 50 is set to the count up position. So long as appliance A is turned on, the counter 58 will count up and the display 32 will show the total number of hours and minutes the appliance has been operated.

As previously mentioned, the operation of the timer when used with other types of apparatus, such as telephones, Internet connections, etc., is the same as described above, the only difference being the level of the voltage or current signal the current/power sensor 62 is designed to sense. A different current/power sensor with different sensing criteria may be connected to the RJ-11 jack 46 for controlling the commencement of timing by the counters 58, 60 when a telephone or other low voltage apparatus is connected to the timer 10.

A microprocessor 66 is provided in the timing circuit 56 to perform functions other than usage timing. For example, a PC may be connected to the microprocessor via PC input 55 and power usage specifications of each of the electrical appliances that may be connected to the timer 10 are programmed into the microprocessor 66 along with the energy cost (dollars/kilowatt-hour) of the local area in which the timer is used. If appliance usage cost information is desired rather than usage time information, the operator uses a PC connected to the PC input 55 to instruct the microprocessor 66 to calculate cost information in dollars and cents based on the output of counter 58. The calculated cost information is transmitted to display 32 where it is displayed as dollars and cents.

A DC voltage converted from 110-120 VAC by the AC/DC converter powers the components of the timing circuit 56. When the power plug 38 of the timer 10 is not plugged into a 110-120 VAC source, power is supplied to the timer by a battery 70. The battery 70 also prevents resetting of the counters 58, 60 in the event of a power interruption during operation of the timer.

Although certain presently preferred embodiments of the present invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. A timer for timing electrical power usage of an electrical apparatus comprising a sensor adapted to be connected to the electrical apparatus for sensing an on condition of the electrical apparatus, a first counter for counting down to zero time from a time greater than zero time set into the first counter, means connected to the first counter for setting a time into the first counter, a second counter for counting up in response to the sensed on condition of the electrical apparatus, a display for displaying the count of the first or second counter and a switch connected between the display and the first and second counters for selecting the count of one of the first and second counters to be displayed.

2. The timer of claim 1, including means for interrupting the electrical power to the electrical apparatus when the first counter has counted down to zero time.

3. The timer of claim 1, including means for resetting the count of the second counter to zero time.

4. The timer of claim 1, wherein said means for setting a time into the first counter is a keypad.

5. The timer of claim 1, including means for stopping and restarting the count of the first counter during the on condition of the electrical apparatus.

6. The timer of claim 1, wherein said electrical apparatus comprises one of an appliance that is powered by 110-120 VAC, a telephone and an Internet connection.

7. The timer of claim 1, wherein the display means is an LED or and LCD display.

8. The timer of claim 1, wherein the electrical apparatus has an electrical connector and an electrical cord and including a timer housing having at least one male electrical connector and at least one female connector for connecting the electrical connector and the electrical cord of the electrical apparatus to the timer.

9. The timer of claim 1, wherein the timer includes a timer housing having at least two male electrical connectors and at least two female connectors for connecting the electrical apparatus to the timer by a selected one of the female connectors.

10. The timer of claim 8, wherein the timer housing has a cover having a first position for accessing and connecting the electrical apparatus to the female connector and a second position for preventing access to the female connector and including means for locking the cover in the second position.

11. The timer of claim 10, including a slot in the cover through which the electrical cord of the electrical apparatus is adapted to pass.

12. The timer of claim 11, wherein said electrical apparatus comprises one of an appliance that is powered by 110-120 VAC, a telephone and an Internet connection.

13. The timer of claim 10, including means for resetting the count of the second counter to zero time, means for stopping and restarting the count of the first counter during the on condition of the electrical apparatus and wherein, in the second position of the cover, the cover prevents access to said switch, said means for setting a time into the first counter, said means for resetting the count of the second counter to zero time and said means for stopping and restarting the count of the first counter.

14. The timer of claim 1, including a programmable microprocessor connected to the first and second counters and the display means, said microprocessor being programmed with power usage specifications of the electrical apparatus and unit cost of electricity for calculating the total cost of electricity used by the electrical apparatus connected to the timer and displaying the total cost on the display means.

15. The timer of claim 8, wherein the male electrical connector is a three-prong power plug mounted on one side of the housing and the female electrical connector is a receptacle for a three-prong plug mounted on a side of the housing opposite the one side on which the male electrical connector is mounted.

16. A programmable timer for timing electrical power usage of an electrical apparatus comprising a sensor adapted to be connected to the electrical apparatus for sensing an on condition of the electrical apparatus, a first counter for counting down to zero time from a time greater than zero time set into the first counter, a keypad connected to the first counter for setting a time into the first counter, a second counter for counting up in response to the sensed on condition of the electrical apparatus, a display for displaying the count of the first or second counter, a switch connected between the display and the first and second counters for selecting the count of one of the first and second counters to be displayed, means for interrupting the electrical power to the electrical apparatus when the first counter has counted down to zero time and means for resetting the count of the second counter to zero time.

17. The programmable timer of claim 16, including means for stopping and restarting the count of the first counter during the on condition of the electrical apparatus.

18. The programmable timer of claim 17, including a timer housing, said timer housing having a female connector for connecting the electrical apparatus to the timer, a cover hingedly connected to the housing, said cover having a first position for accessing and connecting the electrical apparatus to the female connector and a second position for preventing access to the female connector and including means for locking the cover in the second position.

19. The programmable timer of claim 18, wherein, in the second position of the cover, the cover prevents access to said switch, said means for setting a time into the first counter, said means for resetting the count of the second counter to zero time and said means for stopping and restarting the count of the first counter.

20. The programmable timer of claim 16, including a programmable microprocessor connected to the first and second counters and the display means, said microprocessor being programmed with power usage specifications of the electrical apparatus and unit cost of electricity for calculating the total cost of electricity used by the electrical apparatus connected to the timer and displaying the total cost on the display means.
